(19) United States
(12) Patent Application Publication
(10) Pub. No.: US 2025/0100475 A1
(43) Pub. Date: Mar. 27, 2025

(54) COBOT WIRE HARNESS TAPING CELL FOR DATUM INTEGRITY

(71) Applicant: ELECTRICAL COMPONENTS INTERNATIONAL, INC., St. Louis, MO (US)

(72) Inventors: Brian Butters, Point Claire (CA); Patrick Laporte, Montreal (CA)

(21) Appl. No.: 18/897,256

(22) Filed: Sep. 26, 2024

Related U.S. Application Data
(60) Provisional application No. 63/540,788, filed on Sep. 27, 2023.

(51) Int. Cl. B60R 16/02; B25J 9/16

(52) U.S. Cl. CPC B60R 16/0215; B25J 9/1687

(57) ABSTRACT

A method of taping a wiring harness includes longitudinally positioning a wiring harness relative to a taping machine, taping a first datum along the wiring harness with a taper, robotically positioning the wiring harness from the first datum to a second datum, and taping the second datum along the wiring harness with the taper. The resultant taped wiring harness may be used in high voltage vehicle applications, for example.

### CROSS-REFERENCE TO RELATED APPLICATION

This application claims priority to U.S. Provisional Application No. 63/540,788 filed Sep. 27, 2023.

### TECHNICAL FIELD

The disclosure relates to a taping machine, and a method of taping high-voltage wiring covered in a plastic split conduit.

### BACKGROUND

With the proliferation of electrified vehicles, the usage of high-voltage wiring has also increased. A typical electrified vehicle includes a large, high-voltage battery and one or more electric motors used for vehicle propulsion. The electric motors are connected to the battery using large, high-quality high-voltage wiring harnesses. These harnesses include one or more wires surrounded in a flexible plastic split conduit with corrugations. Since these wiring harnesses typically extend a significant length along the vehicle, particularly in commercial bus applications, the harness must be securely supported at numerous locations along the vehicle.

The conduit of the wiring harness has a longitudinal slit along its length that enables the wires to be easily inserted into the conduit during assembly, which protects the underlying wires. This conduit is typically taped at multiple discrete locations to prevent the conduit from opening and the wires from being exposed, and also to provide a more secure mounting point for the wiring harness onto the vehicle.

A typical electrified vehicle includes multiple mounting structures, such as brackets or clamps, arranged at specific locations and spacings from one another along the vehicle. The wiring harness includes support features, such as tape, that must be provided at the same location and spacing. The tape is typically applied by a human operator during manufacture. The operator will measure the distance between the various locations to apply the tape at specified datums that correspond to the mounting structure locations. For long runs of high-voltage wiring, the taped support features do not always correspond to the locations of the mounting structures as the datum integrity is often lost during manufacture. This requires the installer of the wiring harness to provide additional tape or to reject the wiring harness, both of which are very costly.

### SUMMARY

In one exemplary embodiment, a method of taping a wiring harness includes longitudinally positioning a wiring harness relative to a taping machine, taping a first datum along the wiring harness with a taper, robotically positioning the wiring harness from the first datum to a second datum, and taping the second datum along the wiring harness with the taper.

In a further embodiment of any of the above, the longitudinally positioning step is performed by a human operator that positions the wiring harness to establish the first datum, which is a predetermined distance from an end of the wiring harness, relative to a locating feature on the taping machine.

In a further embodiment of any of the above, the end includes at least one wire taped to corrugated conduit arranged about the at least one wire that prevents the wire and conduit from moving relative to one another.

In a further embodiment of any of the above, the method includes the step of a human operator actuating a switch to initiate the subsequently performed first datum taping step.

In a further embodiment of any of the above, the second datum taping step is performed by the robot actuating the switch. The robot is a collaborative robot (cobot).

In a further embodiment of any of the above, the cobot has jaws with a protrusion configured to engage an outer corrugated conduit of the wiring harness to move the wiring harness between the datums.

In a further embodiment of any of the above, the robotically positioning step is performed with the wiring harness arranged along a first longitudinal position, and the taping steps are performed with the wiring harness arranged along a second longitudinal position that is horizontally offset from the first longitudinal position.

In a further embodiment of any of the above, the second longitudinal position is vertically offset from the first longitudinal position. The wiring harness abuts a wall in the second longitudinal position.

In a further embodiment of any of the above, the wiring harness abuts a hook in the first longitudinal position.

In a further embodiment of any of the above, the method includes the step of moving the wiring harness before and after the taping steps with a shuttle between the first and second longitudinal positions. The shuttle translates between the positioning steps and the taping steps to preserve the datums between performing the taping steps.

In a further embodiment of any of the above, the shuttle includes clamps with a protrusion configured to engage an outer corrugated conduit of the wiring harness to move the wiring harness between the first and second longitudinal positions.

In a further embodiment of any of the above, the wiring harness remains secured by the clamps during the taping steps.

In a further embodiment of any of the above, the taper includes a ring with an opening, the ring carrying a roll of tape, and second longitudinal position passes through the ring, and the moving step includes moving the wiring harness in and out of the opening with the shuttle.

In a further embodiment of any of the above, the method includes a cutter, and includes a step of advancing the wiring harness with the shuttle to a third longitudinal position that corresponds to the cutter cutting the tape.

In a further embodiment of any of the above, the taping steps are performed by rotationally driving the ring about the datums with a belt drive.

In another exemplary embodiment, a taping machine includes a multi-axis robot that has an end effector configured to engage a wiring harness, a taper that is configured to tape multiple datums along the wiring harness, a cutter that is configured to cut the tape, and a controller that is in communication with the robot and the taper. The controller is programmed to command the robot to move the wiring harness between the datums, and the controller is programmed to command the taper to tape the datums.

In a further embodiment of any of the above, the taping machine includes a switch that is arranged within reach of the robot. The robot is a collaborative robot (cobot), and the switch is configured to be actuated by both the cobot and a human operator.

In a further embodiment of any of the above, the datums include a first datum nearest an end of the wiring harness, and the switch configured to be actuated by the human operator once the first datum has been positioned in a desired manner relative to the taper.

In a further embodiment of any of the above, the cobot has jaws with a protrusion that is configured to engage an outer corrugated conduit of the wiring harness to move the wiring harness between the datums.

In a further embodiment of any of the above, the taping machine includes a shuttle in communication with the controller. The shuttle is configured to move the wiring harness between first and second longitudinal positions, the robot is configured to handle the wiring harness in the first position, and the taper is configured to tape one of the datums in the second position. The shuttle includes clamps with a protrusion configured to engage an outer corrugated conduit of the wiring harness to move the wiring harness between the first and second longitudinal positions.

These and other features of the present invention can be best understood from the following specification and drawings, the following of which is a brief description.

### BRIEF DESCRIPTION OF THE DRAWINGS

The disclosure can be further understood by reference to the following detailed description when considered in connection with the accompanying drawings wherein:

FIG. 1 is a highly schematic view of an electrified vehicle with multiple wiring harnesses having taped support features provided according to the disclosure.

FIG. 2 is a schematic plan view of the disclosed taping machine.

FIG. 3 is a perspective view of a portion of the taping machine that produces high-voltage wiring harnesses having taped support features applied at highly accurate datum.

FIG. 4 is a side perspective view of a portion of the taping machine.

FIGS. 5A-5C schematically illustrate front, side and end views of clamping members that are used in the taping machine.

FIG. 6 is an enlarged, side perspective view of a taper.

FIG. 7 is a flowchart illustrating a disclosed method of producing a high-voltage wiring harness with the disclosed taping machine.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible. Like reference numbers and designations in the various drawings indicate like elements.

### DETAILED DESCRIPTION

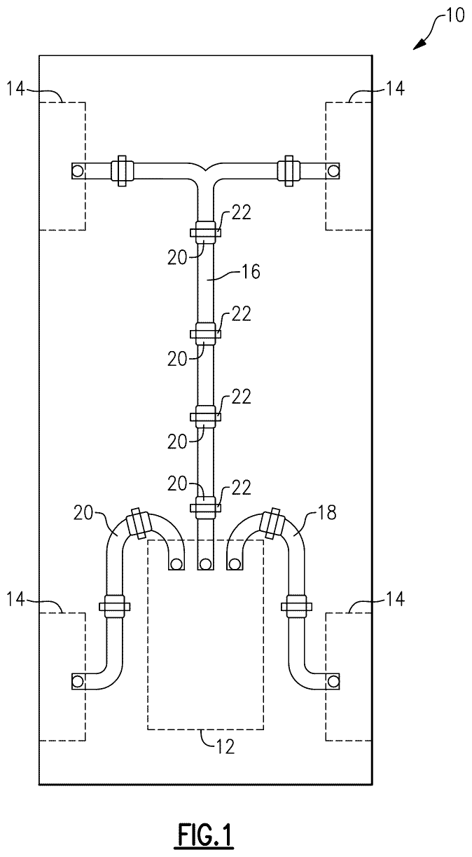

FIG. 1 illustrates one typical electrified vehicle 10 having a high voltage battery 12. The battery 12 is connected to multiple electric motors 14 that propel the vehicle 10 via current supplied by one or more high-voltage wiring harnesses 16-20. To minimize the strain on the wiring harnesses 16-20, multiple mounting structures 24, such as brackets and/or clamps, are used to securely retain the wiring harnesses along its length during operation of the vehicle 10. The wiring harnesses 16 include support features 22, such as tape wrapped about its outer diameter, spaced apart across its length to provide a reinforced area beneath the mounting structures 24, which prevents abrasion.

The electrified vehicle 10 is designed with precision, like any modern vehicle, and the mounting structures 24 are arranged in precise locations throughout the vehicle 10. These locations are provided to the wiring harness manufacturer, which must provide the wiring harnesses with the taped support feature 22 at correspondingly precise locations to ensure alignment of the support feature 22 with the mounting structures 24. The taping machine 26 retains the desired aspects of human intervention in producing a high-voltage wiring harness, while dramatically improving datum integrity of the tape support features 22 along the length of the wiring harness.

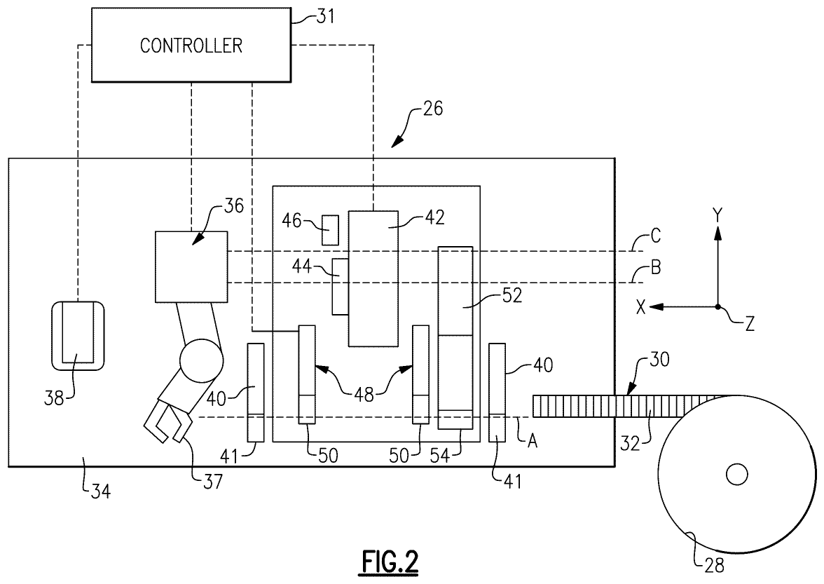

An example taping machine 26 used to provide the taped support features 22 is shown in FIG. 2. The taping machine 26 includes a spool 28 having a wiring harness 30 adjacent to a support surface 34, such as a table. The wiring harness 30 includes one or more wires wrapped in a conduit 32 of flexible plastic with corrugations, also referred to as corrugated wire loom or split wire loom, as is commonly used to protect wires in automotive and other vehicle applications. The corrugations are provided at spaced intervals along the outer diameter of the conduit 32, as is known.

A multi-axis robot (e.g., 6-axis or 7-axis: rotating base, arm with multiple articulating joints, rotating wrist and movable end effector), such as a collaborative robot 36 (“cobot”) is mounted to the support surface 34. The use of a cobot 36 enables the use of a precise robot in the same environment in which a human operator is working without the use of any guards or railings, which are used with a conventional robot for safety. Cobots can safely operate in the same space as human operators without injury in the event of contact between the cobot and the human operator. The cobot 36 includes jaws 37 for selectively engaging the wiring harness 30 is a precise manner. A switch 38 is provided on the support surface within reach of the cobot 36. In the example, the switch 38 is utilized by both the human operator and the cobot 36 during the manufacturing process to control operation of the taping machine 26.

Referring to FIGS. 2, the wiring harness 30 is moved between first, second and third longitudinal positions A, B, C (along an x-axis) during the taping operation. The first longitudinal position A is where the wiring harness 30 is handled by the human operator and cobot 36 to locate the wiring harness at a datum to be taped. Wiring harness taping occurs with the wiring harness 30 in the second longitudinal position B, and the tape is cut at the third longitudinal position C.

Referring to FIGS. 2-4, a pair of guides 40 each having a hook 41 is used to locate the wiring harness 30 by both the human operator and the cobot 36 in the first longitudinal position A outside of a rotary taper 42. A shuttle 48 having a pair of clamps 50 is arranged laterally on either side of the taper 42. The shuttle 48 moves on the y-axis (FIG. 2) to transfer the wiring harness 30 from the first longitudinal position A outside of the taper 42 into the mouth of the taper 42 to a second longitudinal position B in which the tape 44 is applied to the exterior of the conduit 32.

A controller 31 is in communication with the cobot 36, the switch 38, the taper 42 and the shuttle 48. The controller 31 is programmed to command the cobot 36 to move the wiring harness between the datums, and to command shuttle 48 to move the wiring harness 30 relative to the taper 42 to tape the datums.

A ramp 52 is arranged on one side of the taper 42. In the example. The ramp 52 includes a hook 54 that is generally aligned with the hooks 41 in the first longitudinal position A. The ramp 52 also includes first and second steps 56, 58 that provide a transition from the first longitudinal position A to the second longitudinal position B, which is lower than the first longitudinal position A (z-axis, FIG. 2). A wall 60 or ledge is provided between the first and second steps 56, 58 and provides an abutment for locating the wiring harness 30 during the taping operation. The guides 40 include similar transitional ramped structure as the ramp 52.

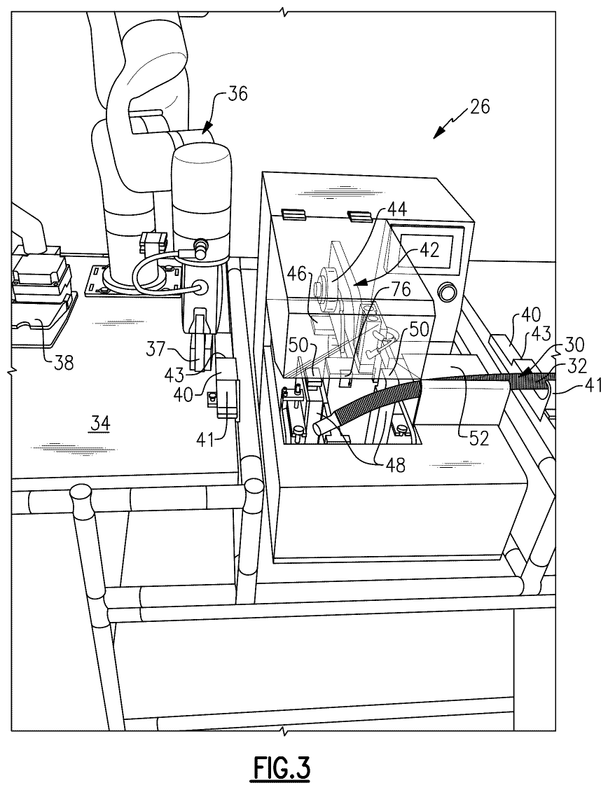

As shown in FIGS. 3 and 4, the taper 42 includes an opening 62 for receiving the wiring harness 30 as it is transferred from the first longitudinal position A to the second longitudinal position B. A belt drive 66 rotationally drives a ring 64 to which one end of the tape 44 is secured.

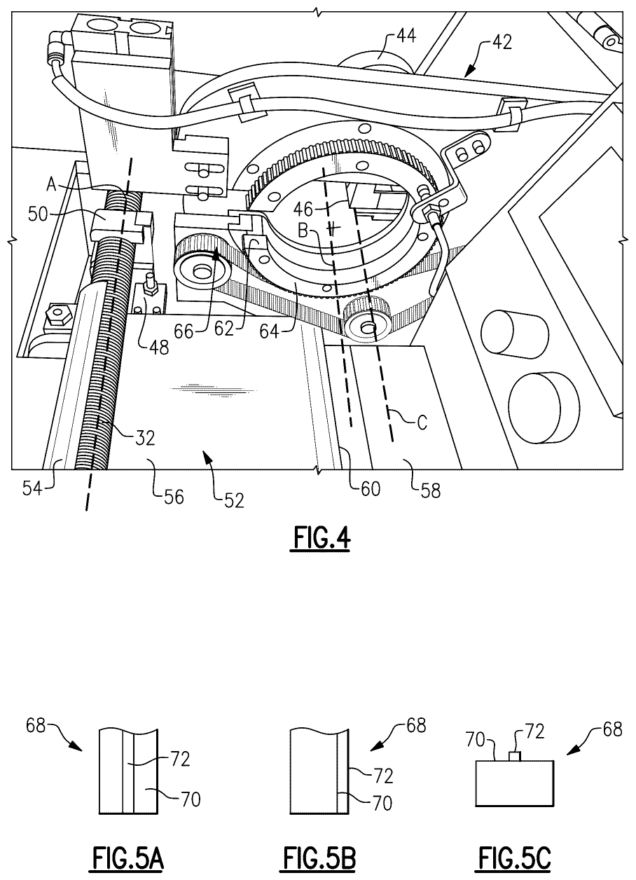

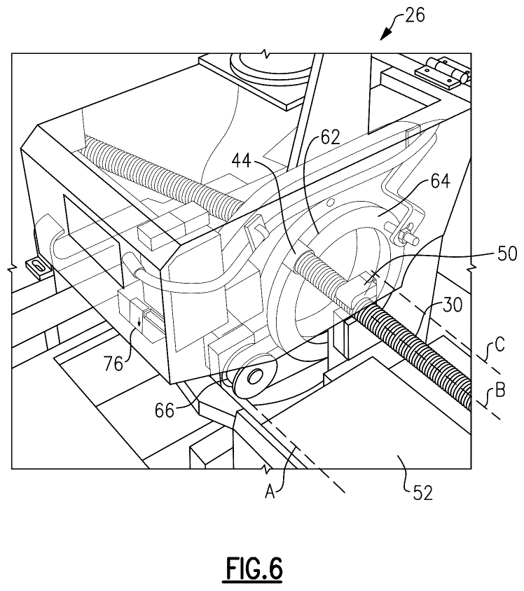

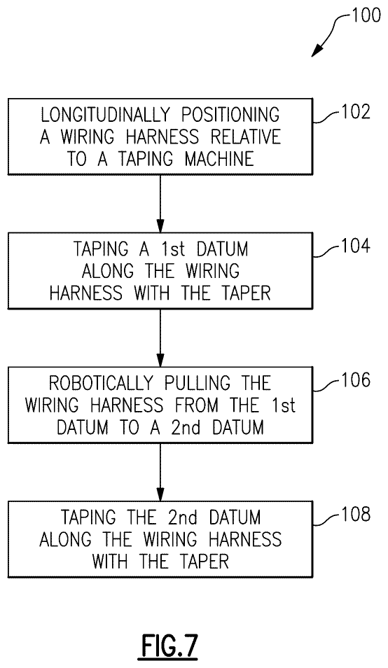

FIGS. 5A-5C illustrate a clamping member 68, which may be used for the jaws 37 and the clamps 50. The clamping member 68 includes a support face 70 having a protrusion 72. The protrusion 72 has a width sized to be received within a valley of adjacent corrugations in the conduit 32. This protrusion 72 enables the jaws 37 to retain and precisely hold the wiring harness 30 as it pulls it from the spool between the datums to be taped. Similarly, the protrusions 72 are provided in the clamps 50, which securely laterally retain the wiring harness 30 during the taping operation (FIG. 6).

In operation (FIG. 6, method 100), a human operator grabs hold of an end of the wiring harness 30 and pulls it from the spool 28 along the first position longitudinal to the first datum to be taped (block 102). The wiring harness 30 is arranged within the hooks 41 and the hook 54. The end includes at least one wire taped to the conduit 32, which prevents the wire and conduit from moving relative to one another. This first datum may be measured manually or by using a fixture, for example, and a mark may be placed on the wiring harness 30 by a human operator. This mark may then be aligned with an indicator 76 on the taping machine 26.

With the first datum determined, all subsequent datum can be precisely achieved using the cobot 36 and shuttle 48, which both include the protrusion 72 that accurately moves the wiring harness 30 throughout the duration of the taping operation. At this point, a human operator presses the switch 38, which initiates all the subsequent taping steps that are now fully automated by the taping machine 26 without the need of human intervention.

The clamps 50 close about the wiring harness 30 and slide aftward (y-axis) transverse to the first and second longitudinal axes A and B, through the opening 62 in the ring 64 of the taper 42. During this motion, in which the clamps 50 remain closed, the wiring harness 30 is dragged down the guides 40 and ramp 52 by the shuttle 48 and lowered to the second longitudinal position B, which is vertically below than the first longitudinal axis. A sensor detects the presence of the wiring harness 30 in the second longitudinal position B, which actuates the taper 42 to wrap tape 44 about the conduit 32 (block 104). After a predetermined number of rotations of tape 44 about the datum, the shuttle moves the wiring harness 30 aftward (y-axis) from the second longitudinal position B to the third longitudinal position C causing the cutter 46 to cut the tape 44.

Once the taping is complete, the shuttle 48 returns the wiring harness 30 from the third longitudinal position C to the first longitudinal position A. The clamps 50 open, and the cobot 36 grabs the wiring harness 30 with jaws 37 and drags it from the completed taped support feature to the next datum (block 106). Unlike a human operator, the cobot 36 is able to pull the wiring harness with consistent motion and repeatable force, which ensures accurate distance between the datums. Once the next datum to be taped is precisely positioned, the switch 38 is actuated by the jaws 37 as the cobot 36 initiates the subsequent taping operation. The taping process is repeated in the automated fashion by the cobot 36 until all taped support features have been provided (block 108).

As described above, the controller 31 can be used to implement the various functionality disclosed in this application. The controller 31 may include one or more discrete units. In terms of hardware architecture, such a computing device can include a processor, memory, and one or more input and/or output (I/O) device interface(s) that are communicatively coupled via a local interface. The local interface can include, for example but not limited to, one or more buses and/or other wired or wireless connections. The local interface may have additional elements, which are omitted for simplicity, such as controllers, buffers (caches), drivers, repeaters, and receivers to enable communications. Further, the local interface may include address, control, and/or data connections to enable appropriate communications among the aforementioned components.

The controller 31 may be a hardware device for executing software, particularly software stored in memory. The controller 31 can be a custom made or commercially available processor, a central processing unit (CPU), an auxiliary processor among several processors associated with the controller, a semiconductor-based microprocessor (in the form of a microchip or chip set) or generally any device for executing software instructions.

The memory can include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). Moreover, the memory may incorporate electronic, magnetic, optical, and/or other types of storage media. The memory can also have a distributed architecture, where various components are situated remotely from one another, but can be accessed by the processor.

The software in the memory may include one or more separate programs, each of which includes an ordered listing of executable instructions for implementing logical functions. A system component embodied as software may also be construed as a source program, executable program (object code), script, or any other entity comprising a set of instructions to be performed. When constructed as a source program, the program is translated via a compiler, assembler, interpreter, or the like, which may or may not be included within the memory.

The disclosed input and output devices that may be coupled to system I/O interface(s) may include input devices, for example but not limited to, a keyboard, mouse, scanner, microphone, camera, mobile device, proximity device, etc. Further, the output devices, for example but not limited to, a printer, display, etc. Finally, the input and output devices may further include devices that communicate both as inputs and outputs, for instance but not limited to, a modulator/demodulator (modem; for accessing another device, system, or network), a radio frequency (RF) or other transceiver, a telephonic interface, a bridge, a router, etc.

When the controller 31 is in operation, the processor can be configured to execute software stored within the memory, to communicate data to and from the memory, and to generally control operations of the computing device pursuant to the software. Software in memory, in whole or in part, is read by the processor, perhaps buffered within the processor, and then executed.

It should also be understood that although a particular component arrangement is disclosed in the illustrated embodiment, other arrangements will benefit herefrom. Although particular step sequences are shown, described, and claimed, it should be understood that steps may be performed in any order, separated or combined unless otherwise indicated and will still benefit from the present invention.

Although the different examples have specific components shown in the illustrations, embodiments of this invention are not limited to those particular combinations. It is possible to use some of the components or features from one of the examples in combination with features or components from another one of the examples.

Although an example embodiment has been disclosed, a worker of ordinary skill in this art would recognize that certain modifications would come within the scope of the claims. For that reason, the following claims should be studied to determine their true scope and content.

What is claimed is:

1. A method of taping a wiring harness, comprising:
longitudinally positioning a wiring harness relative to a taping machine;
taping a first datum along the wiring harness with a taper;
robotically positioning the wiring harness from the first datum to a second datum; and
taping the second datum along the wiring harness with the taper.

2. The method of claim 1, wherein the longitudinally positioning step is performed by a human operator positioning the wiring harness to establish the first datum, which is a predetermined distance from an end of the wiring harness, relative to a locating feature on the taping machine.

3. The method of claim 2, wherein the end includes at least one wire taped to corrugated conduit arranged about the at least one wire preventing the wire and conduit from moving relative to one another.

4. The method of claim 2, comprising the step a human operator actuating a switch to initiate the subsequently performed first datum taping step.

5. The method of claim 4, wherein the second datum taping step is performed by the robot actuating the switch, wherein the robot is a collaborative robot (cobot).

6. The method of claim 5, wherein the cobot has jaws with a protrusion configured to engage an outer corrugated conduit of the wiring harness to move the wiring harness between the datums.

7. The method of claim 1, wherein the robotically positioning step is performed with the wiring harness arranged along a first longitudinal position, and the taping steps are performed with the wiring harness arranged along a second longitudinal position that is horizontally offset from the first longitudinal position.

8. The method of claim 7, wherein the second longitudinal position is vertically offset from the first longitudinal position, the wiring harness abutting a wall in the second longitudinal position.

9. The method of claim 7, wherein the wiring harness abuts a hook in the first longitudinal position.

10. The method of claim 1, comprising the step of moving the wiring harness before and after the taping steps with a shuttle between the first and second longitudinal positions, wherein the shuttle translates between the positioning steps and the taping steps to preserve the datums between performing the taping steps.

11. The method of claim 10, wherein the shuttle includes clamps with a protrusion configured to engage an outer corrugated conduit of the wiring harness to move the wiring harness between the first and second longitudinal positions.

12. The method of claim 11, wherein the wiring harness remains secured by the clamps during the taping steps.

13. The method of claim 10, wherein the taper includes a ring with an opening, the ring carrying a roll of tape, and second longitudinal position passes through the ring, and the moving step included moving the wiring harness in and out of the opening with the shuttle.

14. The method of claim 13, comprising a cutter, and including a step of advancing the wiring harness with the shuttle to a third longitudinal position corresponding to the cutter cutting the tape.

15. The method of claim 13, wherein the taping steps are performed by rotationally driving the ring about the datums with a belt drive.

16. A taping machine comprising:
a multi-axis robot having an end effector configured to engage a wiring harness;
a taper configured to tape multiple datums along the wiring harness;
a cutter configured to cut the tape; and
a controller in communication with the robot and the taper, the controller programmed to command the robot to move the wiring harness between the datums, and the controller programmed to command the taper to tape the datums.

17. The taping machine of claim 16, comprising a switch arranged within reach of the robot, wherein the robot is a collaborative robot (cobot), and the switch is configured to be actuated by both the cobot and a human operator.

18. The taping machine of claim 17, wherein the datums include a first datum nearest an end of the wiring harness, and the switch configured to be actuated by the human operator once the first datum has been positioned in a desired manner relative to the taper.

19. The taping machine of claim 16, wherein the cobot has jaws with a protrusion configured to engage an outer corrugated conduit of the wiring harness to move the wiring harness between the datums.

20. The taping machine of claim 16, comprising a shuttle in communication with the controller, the shuttle configured to move the wiring harness between first and second longitudinal positions, the robot configured to handle the wiring harness in the first position, and the taper configured to tape one of the datums in the second position, shuttle includes clamps with a protrusion configured to engage an outer corrugated conduit of the wiring harness to move the wiring harness between the first and second longitudinal positions.
